(19) United States
(12) Patent Application Publication
(10) Pub. No.: US 2013/0127986 A1
(43) Pub. Date: May 23, 2013

(54) COMMON HOLOGRAPHIC IMAGING PLATFORM

(71) Applicants: David A. Richards, Medford, MA (US); Liberty L. Seaford, Bristow, VA (US); Andrew Reeves, E. Merrimack, NH (US)

(72) Inventors: David A. Richards, Medford, MA (US); Liberty L. Seaford, Bristow, VA (US); Andrew Reeves, E. Merrimack, NH (US)

(73) Assignee: BAE Systems Information and Electronic Systems Integration Inc., Nashua, NH (US)

(21) Appl. No.: 13/299,522

(22) Filed: Nov. 18, 2011

(51) Int. Cl. H04N 5/89

(52) U.S. Cl. 348/40; 348/E05.001

(57) ABSTRACT

An imaging system and method is provided with transition in depth of field, the system comprising: an array of selectably activated sensors comprising first sensors receiving light of a first wavelength and second sensor receiving light of a second wavelength, the first wavelength corresponding to a short effective focal length and the second wavelength corresponding to a long effective focal length; an aperture common to both the first and second sensors configured with chromatic distortion such that a focal plane of light of the first wavelength is different from light of the second wavelength; a controller, the controller digitally between outputs of the first and second sensors based on the focal length required.

### FIELD OF THE INVENTION

The invention relates to optical systems, and more particularly, to a light weight head mounted imaging system with rapid transitions from far field to near field focus.

### BACKGROUND OF THE INVENTION

Know night vision displays utilize direct axis displays which are both heavy and obstruct the vision of users. The weight of such devices in head mounted systems provides stress on the user's neck. Obstructed vision caused by a monocle or other visor is likewise potentially hazardous to soldiers in the field.

Typical optical systems have focusing at far field is required relatively infrequently, however at near field images rapidly lose focus and must be refocused as the distance between the user and the target item changes. In situations where a user must rapidly view both near field and far field images, the focus at each translation would introduce significant delays and periods of loss of clarity. In field operations, operatives require uninterrupted vision. Thus, current devices are not suitable for covert breeching operations including Close Quarters Battle (CQB) engagements.

At close ranges the depth of field is so small that several focus changes are required to resolve targets at varying close ranges (1-15 m)
Desire for the device to serve multiple roles, including
Day camera replacement for photography
Ability to transmit imagery to command
Utilization in the daytime for providing augmented reality imaging.

What is needed, therefore, are techniques for visual display minimum weight, low profile, and be capable of day/night performance and near/long ranges.

### SUMMARY OF THE INVENTION

One embodiment of the present invention provides a system for imaging with transition in depth of field, the system comprising: an array of selectably activated sensors comprising first sensors receiving light of a first wavelength and second sensor receiving light of a second wavelength, the first wavelength corresponding to a short effective focal length and the second wavelength corresponding to a long effective focal length; an aperture common to both the first and second sensors configured with chromatic distortion such that a focal plane of light of the first wavelength is different from light of the second wavelength; and a controller, the controller digitally between outputs of the first and second sensors based on the focal length required.

Another embodiment of the present invention provides such a system wherein the first sensors and the second sensor are configured with first and second filters permitting light of the first and second wavelengths respectively to pass through the filter.

A further embodiment of the present invention provides such a system wherein the first and second filters comprise lenslets.

Yet another embodiment of the present invention provides such a system wherein the first and second filters are plasmonic filters.

A yet further embodiment of the present invention provides such a system wherein the light of a first wavelength has a wavelength of between about approximately 520 and 570 nm. 6. The system of claim 1 wherein the light of a second wavelength has a wavelength of between about approximately 630 and 740 nm.

Still another embodiment of the present invention provides such a system wherein the chromatic distortion is axial chromatic distortion.

One embodiment of the present invention provides a system for visual digital display the system comprising: a display disposed proximate to a user's eye and displaying; an array of sensors disposed parallel to the visual axis of the user's eye; the array of sensors collecting data converted into a visual image and displayed on the display, sensors within the array of sensors being selectable by a controller and configured to receive light of a specific wavelength; a common aperture admitting light to the array of sensors, the common aperture being configured with a chromatic distortion; and a controller digitally selecting sensors within the array of a desired depth of field.

Another embodiment of the present invention provides such a system wherein the chromatic distortion is an axial chromatic distortion.

A further embodiment of the present invention provides such a system further comprising graphic overlays on the display.

Still another embodiment of the present invention provides such a system further comprising a chip on thermal imager housing in which the array of sensors is disposed.

A still further embodiment of the present invention provides such a system wherein the display is a holographic display.

Yet another embodiment of the present invention provides such a system wherein the display is retinal painting.

A yet further embodiment of the present invention provides such a system further comprising a head mount whereby the system is affixed to a user's head.

One embodiment of the present invention provides a method for the transition between depth of field, the method comprising: collecting light from a field of view through a double focus/chromatic focus objective lens configured with an chromatic distortion; filtering the light through first and second filters associated with first and second sensors within an array of sensors, such that light entering the first sensor through the first filter focus has a different focus point than light entering the second sensor through the second filter; and digitally selecting between the first and second sensors, thereby selecting the depth of field.

The features and advantages described herein are not all-inclusive and, in particular, many additional features and advantages will be apparent to one of ordinary skill in the art in view of the drawings, specification, and claims. Moreover, it should be noted that the language used in the specification has been principally selected for readability and instructional purposes, and not to limit the scope of the inventive subject matter.

### BRIEF DESCRIPTION OF THE DRAWINGS

FIG. 1 is a block diagram illustrating a perspective view of a visual image system configured in accordance with one embodiment of the present invention.

FIG. 2 is a block diagram illustrating a cross sectional perspective view of a visual image system configured in accordance with one embodiment of the present invention.

FIG. 3A is a block diagram illustrating a side perspective view of a visual image system mounted on known dust goggles and configured in accordance with one embodiment of the present invention.

FIG. 3B is a block diagram illustrating a front perspective view of a visual image system mounted on known dust goggles and configured in accordance with one embodiment of the present invention.

FIG. 4A is a block diagram illustrating a side perspective view of a visual image system mounted on known sunglass frames and configured in accordance with one embodiment of the present invention.

FIG. 4B is a block diagram illustrating a front perspective view of a visual image system mounted on known sunglass frames and configured in accordance with one embodiment of the present invention.

FIG. 5A is a block diagram illustrating a side perspective view of a visual image system mounted on alternative known sunglass frames with cloth head mounts and configured in accordance with one embodiment of the present invention.

FIG. 5B is a block diagram illustrating a front perspective view of a visual image system mounted on alternative known sunglass frames with cloth head mounts and configured in accordance with one embodiment of the present invention.

FIG. 6 is a block diagram illustrating a transition in focus change in a system configured in accordance with one embodiment of the present invention.

FIG. 7 is a block diagram illustrating a visual image system configured in accordance with one embodiment of the present invention.

FIG. 8 is a flow chart illustrating a visual image method configured in accordance with one embodiment of the present invention.

### DETAILED DESCRIPTION

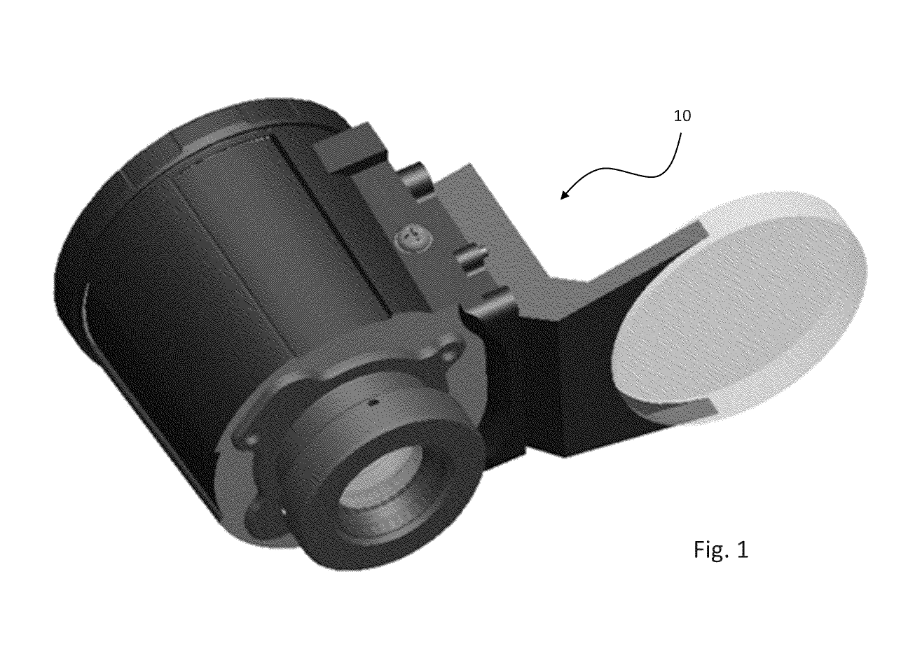

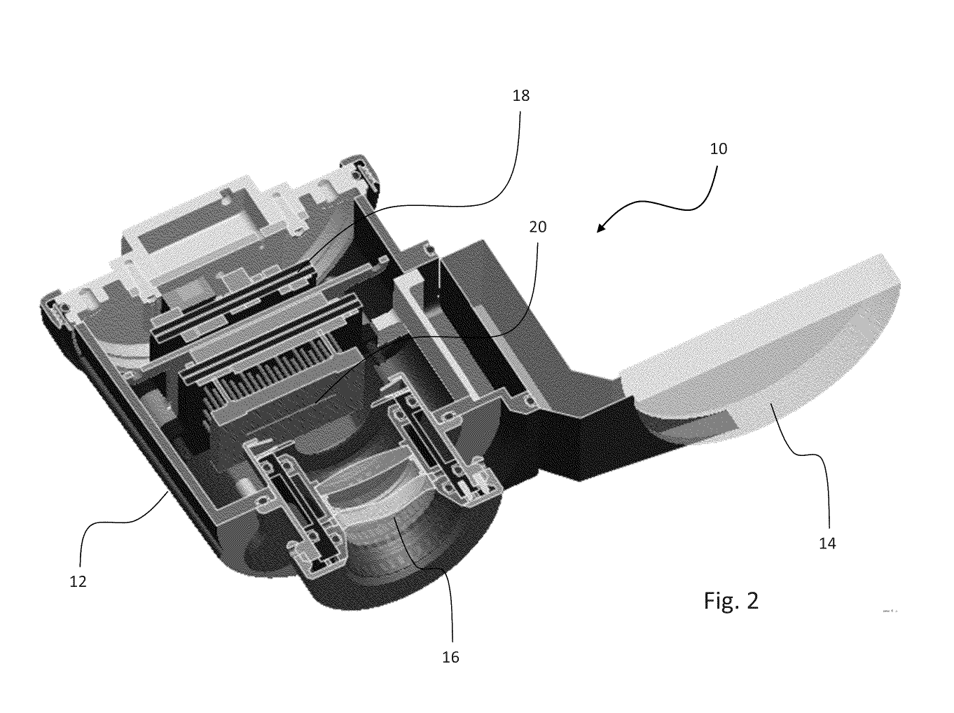

One embodiment of the present invention illustrated in FIG. 1, a cross section of which is illustrated in FIG. 2, provides a Common Holographic Imaging Platform 10 that provides a universal, digital imaging platform that is the main display component of the envisioned digital battlefield (replaces Land Warrior monocle) for viewing maps, communications, photographs, data, etc. The overlays that are correlated to world around the user (waypoints, target boxes, Virtual Reticule, compass, markers overlaid on the world) for augmented reality day or night through Gen III quality night imaging performance as well as day time image recording. One embodiment of the present invention is integrated to the soldier, not the helmet. It is small enough to be worn all day and all night without excessive fatigue. It becomes as standard a piece of equipment as the weapon, helmet, or boots and is the war fighter's optical interface to the digital battlefield day and night.

Battery power and system controls are, in one embodiment positioned on the users person, (not shown) armor to reduce head mounted size and weight profile. Additionally, a projection configured according to one embodiment of the present invention has see-through projection technology for situational awareness, depth projection and image overlay

In one embodiment of the present invention illustrated in FIG. 2, a chip on thermal imager (COTI) style housing construction 12 is provided, manufactured from injection molded Magnesium or other advanced materials to allow light weight head mounted imaging. Housings may be configured to be disposed on a number of mounts, including but not limited to helmet mounted systems, existing WileyX frames, Oakley Frames, and existing dust google designs.

In one such embodiment, the eye piece of the imager 14 comprises the largest size and weight component. In order to minimize size and weight, a holographic projection such as that described in U.S. Pat. No. 7,283,307 which is herein incorporated in its entirety for all purposes. In such an embodiment, the sensor array may be disposed parallel to the axis of vision of the user, with the user able to see through the holographic projection while visual overlays of target data, maps, thermal or low level images are overlaid upon the projection. In alternative embodiments, retinal projection or other similar techniques may be employed.

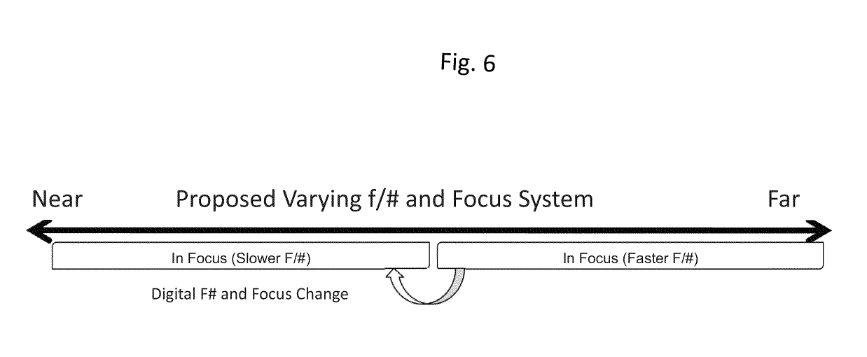

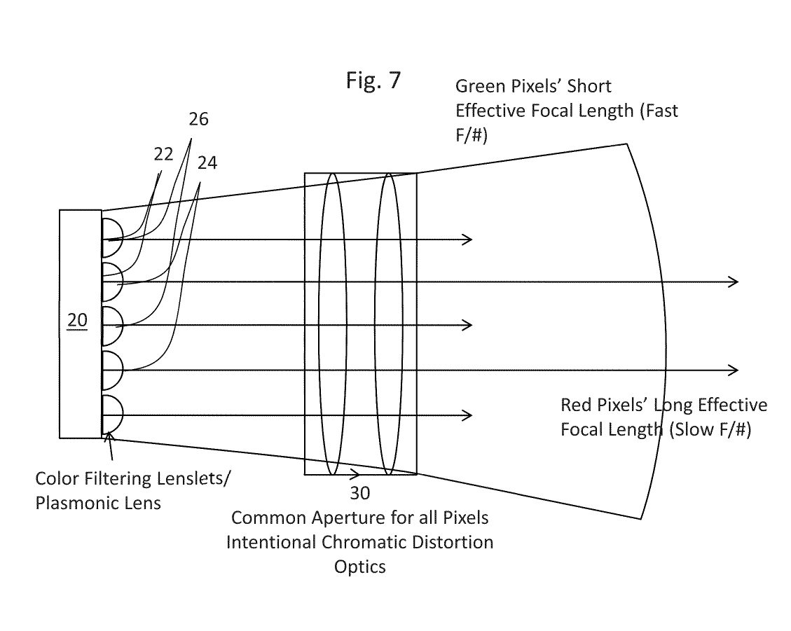

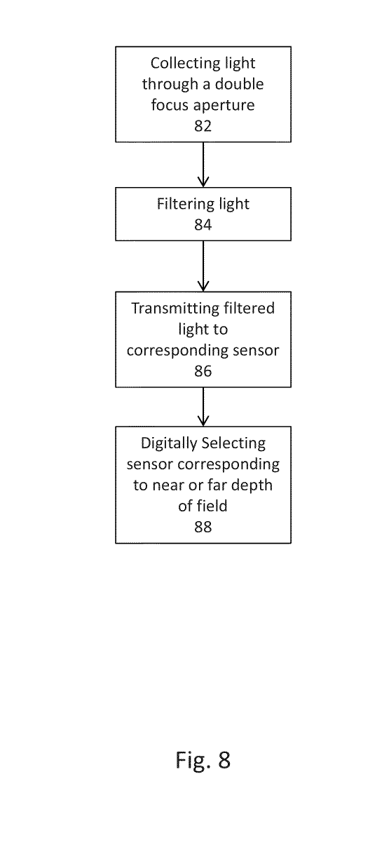

Double Focus/Chromatic Focus Objective Lens 16 are provided configured to induce an intentional axial chromatic distortion as discussed at length with regard to FIGS. 6 and 7. This axial distortion allows for different foci for different colors of light. Which, in combination with an array of sensors 20 configured to receive specific wavelengths of light, or an array of sensors fitted with a plurality of variable lenslets or filters 24, 26, such as those of the Radiance family of sensors, with variable lenslet/plasmonic filtering/focusing, allowing different sensors within the array to detect different wavelengths of light. The different wavelengths of light focus at different points, allowing one wavelength to have a fast depth of field suitable for distance while another has a slow depth of field suitable for near field vision. In one embodiment red light (630-740 nm) may relate to far field applications, while green light (520-570 nm) may adapt itself to near field applications.

Image processing electronics 18 may be disposed within the housing, in one embodiment AI-1000 electronics are used for image processing, video in/video out, overlay.

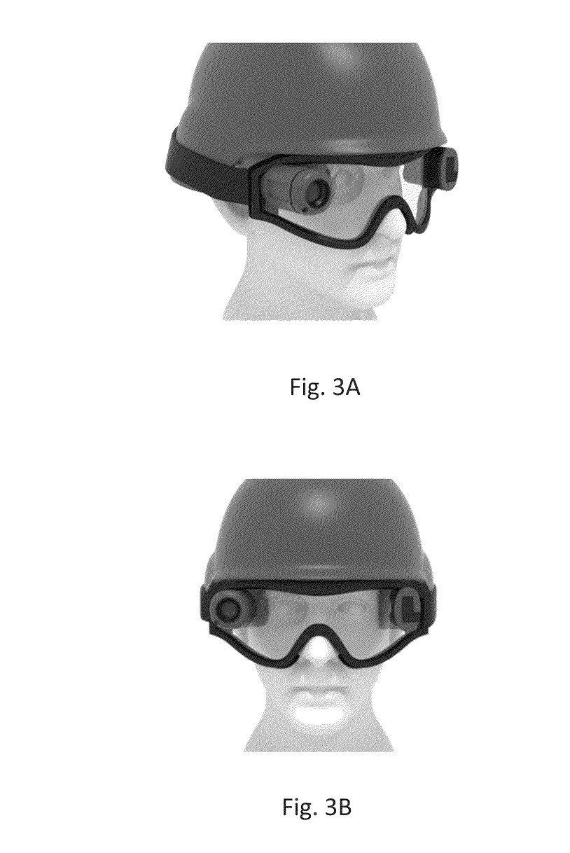

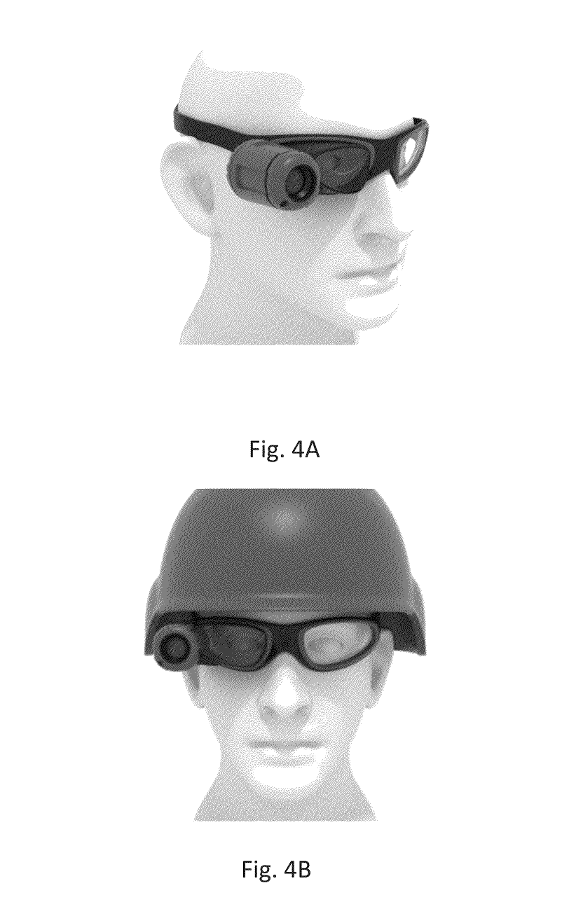

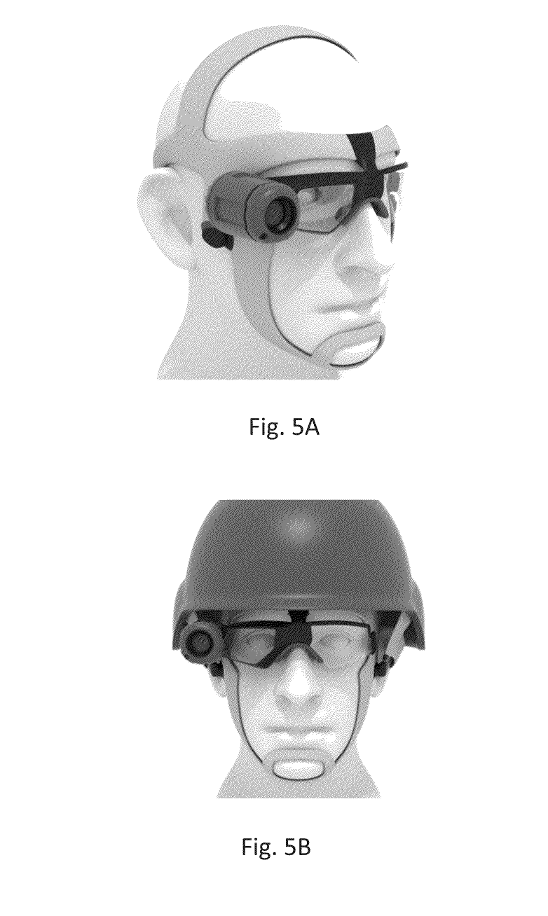

As discussed above, head level integrated mounting, illustrated in various forms in FIG. 3A-5B (Possible integration with eye protection) with electronics can be provided in fabric conductors to allow for quick disconnect with armor and other user mounted equipment.

In one embodiment of the present invention a head mounted night vision display is provided with both different depth of field for near and far field applications. A transition between the far field and near field modes as illustrated in FIG. 6 is beneficial in dynamic situations. As illustrated in FIG. 7, a sensor array 20 with a plurality of sensors 22 is provided whereby a plurality of pixels are generated. Each sensor 22 in said array 20 is equipped with a color filtering lenslet or plasmonic lens 24, 26. Each lenslet is of a particular color filter such that a first lenslet 24 may filter light of one wavelength, while a second lenslet 26 filters light of a second wavelength. A common aperture 30 is provided for with an intentional chromatic distortion imbedded in the optics 16 of the aperture such that light of the wavelength of the first lenslet 24 has a short effective focal length, while light of the wavelength of the second lenslet 26 has a long effective focal length. In alternative embodiments, rather than providing lenslets that filter different wavelengths of light, sensors in the array may be configured to be sensitive to different wavelengths. The common aperture may be a double focus or chromic focus objective lens.

As illustrated in the flow chart of FIG. 9, a method for transitioning between fast and slow lenses digitally includes collecting the light through a common aperture or double focus lens 82. The aperture has an inherent and know chromatic distortion. Filtering 84 that light through filter lenslets or plasmonic filters which are associated with specific sensors in an array of sensors, such that each filter is filtering the light entering a specific sensor. Allowing the light to reach each sensor to thereby receive light of a specific wavelength 86. As the light of different wavelengths has passed through the lens with chromic distortion, the focal distance for the light of different wavelengths will be different. The system may then adjust for different depths of field digitally by selecting the sensors of the appropriate depth of field.

The foregoing description of the embodiments of the invention has been presented for the purposes of illustration and description. It is not intended to be exhaustive or to limit the invention to the precise form disclosed. Many modifications and variations are possible in light of this disclosure. It is intended that the scope of the invention be limited not by this detailed description, but rather by the claims appended hereto.

What is claimed is:

1. A system for imaging with transition in depth of field, the system comprising:
an array of selectably activated sensors comprising first sensors receiving light of a first wavelength and second sensor receiving light of a second wavelength, said first wavelength corresponding to a short effective focal length and said second wavelength corresponding to a long effective focal length;
an aperture common to both said first and second sensors configured with chromatic distortion such that a focal plane of light of said first wavelength is different from light of said second wavelength;
a controller, said controller digitally between outputs of said first and second sensors based on the focal length required.

2. The system of claim 1 wherein said first sensors and said second sensor are configured with first and second filters permitting light of said first and second wavelengths respectively to pass through said filter.

3. The system of claim 2 wherein said first and second filters comprise lenslets.

4. The system of claim 2 wherein said first and second filters are plasmonic filters.

5. The system of claim 1 wherein said light of a first wavelength has a wavelength of between about approximately 520 and 570 nm.

6. The system of claim 1 wherein said light of a second wavelength has a wavelength of between about approximately 630 and 740 nm.

7. The system of claim 1 wherein said chromatic distortion is axial chromatic distortion.

8. A system for visual digital display said system comprising:
a display disposed proximate to a user's eye and displaying;
an array of sensors disposed parallel to the visual axis of said user's eye;
said array of sensors collecting data converted into a visual image and displayed on said display, sensors within said array of sensors being selectable by a controller and configured to receive light of a specific wavelength;
a common aperture admitting light to said array of sensors, said common aperture being configured with a chromatic distortion; and
a controller digitally selecting sensors within said array of a desired depth of field.

9. The system of claim 8 wherein said chromatic distortion is an axial chromatic distortion.

10. The system of claim 8 further comprising graphic overlays on said display.

11. The system of claim 8 further comprising a chip on thermal imager housing in which said array of sensors is disposed.

12. The system of claim 8 wherein said display is a holographic display.

13. The system of claim 8 wherein said display is retinal painting.

14. The system according to claim 8 further comprising a head mount whereby said system is affixed to a user's head.

15. A method for the transition between depth of field, said method comprising:
collecting light from a field of view through a double focus/chromatic focus objective lens configured with an chromatic distortion;
filtering said light through first and second filters associated with first and second sensors within an array of sensors, such that light entering said first sensor through said first filter focus has a different focus point than light entering said second sensor through said second filter; and
digitally selecting between said first and second sensors, thereby selecting the depth of field.
